(19) United States
(12) Patent Application Publication
(10) Pub. No.: US 2016/0370107 A1
(43) Pub. Date: Dec. 22, 2016

(54) REFRIGERATOR PROVIDING LOCAL COOLING

(71) Applicant: Dongbu Daewoo Electronics Corporation, Seoul (KR)

(72) Inventors: Sung Jin MOON, Seoul (KR); Seong Jin KIM, Seoul (KR); Jong Woong KIM, Seoul (KR)

(21) Appl. No.: 14/837,963

(22) Filed: Aug. 27, 2015

(30) Foreign Application Priority Data
Jun. 16, 2015 (KR) 10-2015-0085399

(51) Int. Cl. F25D 29/00; G01J 5/00; F25D 17/06

(52) U.S. Cl. CPC F25D 29/005; F25D 17/062; G01J 5/0003

(57) ABSTRACT

A refrigerator capable of detecting a stored item having a higher-than-ambient temperature and accordingly directing a cool airflow thereto for rapid cooling. The refrigerator includes a thermal image capturing unit for sensing a temperature of the item, a position sensing unit for locating the item in the storage space. A control unit can control a temperature and/or a direction of the cool air discharged from a cool air discharge unit via a fan unit based on the sensed temperature and position of the item.

### RELATED APPLICATIONS

This application claims priority to Korean Patent Application No. 10-2015-0085399, filed on Jun. 16, 2015, the disclosure of which is herein incorporated by reference in its entirety for all purposes.

### FIELD OF THE INVENTION

The present invention relates to refrigerators, and more particularly, to the cooling control mechanisms in refrigerators.

### BACKGROUND OF THE INVENTION

A refrigerator is an electrical appliance to keep food cold or frozen by circulating refrigerant in a cooling cycle.

Typically, a temperature sensing unit is installed in the refrigerator to sense a temperature at a particular point. The sensed temperature is representative of the overall temperature of the entire storage space. When the overall temperature is higher than a predetermined or user-configured value, cool air is supplied to the storage space to reduce the temperature.

When an item is first brought from outside to the storage space, it usually has a temperature higher than the ambient temperature inside the refrigerator. This item can cause the ambient temperature of the storage space to increase via convection. If the temperature sensing unit senses the temperature increase, additional cool air is supplied to the storage space. Thus, the ambient temperature as well as the temperature of the item can be cooled. Cool air has to be continuously supplied until the sensed temperature reaches the predetermined value.

As shown in FIG. 1, the refrigerator has a temperature T₀ (e.g., a predetermined ambient temperature) at time to, and changes to a temperature T₁ when a higher-than-ambient-temperature item is placed into the storage space at time t₀. In response to the temperature increase as detected by the temperature sensing unit, a relatively large amount of cool air is supplied and circulated in the storage space until the temperature of the refrigerator is lowered to the original temperature T₀, as shown at time t₂.

Conventionally, the temperature sensing unit can only sense the temperature of a particular fixed location in the refrigerator, usually where the temperature sensor is located. Therefore, the supply of cooling air is controlled based on the sensed temperature of the fixed location. The temperature sensor at the fixed location cannot detect an uneven temperature distribution in the refrigerator. Thus, the cooling is usually inefficient and tends to waste extra energy, especially in the scenario that the storage space temperature is elevated due to a small volume object placed far away from the temperature sensing unit, e.g., a room-temperature item just introduced to the refrigerator.

### SUMMARY OF THE INVENTION

Embodiments of the present invention are directed to providing a refrigerator with enhanced cooling efficiency through local cooling.

Embodiments of the present disclosure provide a refrigerator capable of detecting a particular stored item with higher-than-ambient temperature and accordingly cool off the item by supplying intense cool airflow locally.

According to one embodiment of the present disclosure, a refrigerator includes: a main body formed with a storage space containing an item; a door mounted on the main body to isolate the storage space from the outside by being opened and closed, a refrigerating cycle device for supplying cool air to the storage space; a cool air discharge unit for discharging the cool air; a thermal image capturing unit for sensing a temperature of the item; a position sensing unit for sensing a position of the item in the storage space; and a control unit for controlling a temperature and/or a direction of the cool air based on the temperature and position of the item.

Further, the thermal image capturing unit may be disposed on a ceiling surface inside the storage space.

Further, the thermal image capturing unit may be disposed on the ceiling surface and proximate to the front side of the refrigerator.

Further, the thermal image capturing unit includes a lens having a wide angle of view.

Further, the refrigerator includes at least one partition dividing the storage space into a plurality of chambers. A position sensing unit can identify the chamber containing the item and transmit the sensed result to the control unit.

Further, the position sensing unit can sense the lateral and vertical positions of the item with reference to the refrigerator.

Further, the refrigerator includes a cooling fan unit for providing the cool air discharged from the cool air discharge unit with circulation force. Controlled by the control unit, a discharge direction of the cool air can be adjusted. Based on the sensed temperature and position of the item, the control unit controls a temperature or a direction of the cool air from the cooling fan unit.

Another embodiment of the present invention provides a method for controlling a refrigerator and the method includes: sensing a temperature of an item stored in the refrigerator; sensing a position of the item; generating cool air to be supplied to the storage space and controlling cool air discharge by adjusting a temperature or a discharge direction of the cool air based on the temperature and position of the item.

Further, a temperature of the item is sensed using a thermal image capturing unit disposed on a ceiling surface inside the storage space.

Further, if the storage space has multiple storage chambers, the chamber storing the item can be identified, which is also used to control the cool air discharge.

Further, the sensed position of the item includes a lateral position and a vertical position with reference to the refrigerator.

Further, the method includes controlling a cooling fan unit to face the item based on the temperature and position of the item. Thus the fan unit can push the strongest portion of the cool airflow to the item.

According to embodiments of the present invention, the temperature and position of an item with a high-than-ambient-temperature stored in a storage space can be sensed. Accordingly, concentrated cool air can directed to the item based on the sensed result. In this manner, the high-than-ambient-temperature item can be cooled off more rapidly. Its impact on the ambient temperature of the refrigerator is advantageously reduced. As a result, power consumption of the refrigerator may be reduced.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 is a view illustrating temperature variation when an item is placed into a storage space of a refrigerator;

FIGS. 2A and 2B illustrate the functional components of an exemplary refrigerator according to an embodiment of the present invention;

FIGS. 3 and 4 illustrate the operation and configuration of an exemplary refrigerator according to an embodiment of the present invention;

FIG. 5 illustrates adjustment of a direction of a cooling fan in an exemplary refrigerator according to an embodiment of the present invention; and

FIG. 6 illustrates an exemplary method for controlling the cooling system of the refrigerator according to an embodiment of the present invention.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

### Refrigerator Providing Local Cooling

The term ‘refrigerator’ used herein refers to a cooling/freezing apparatus embodied with a cooler, a freezer or a combination thereof.

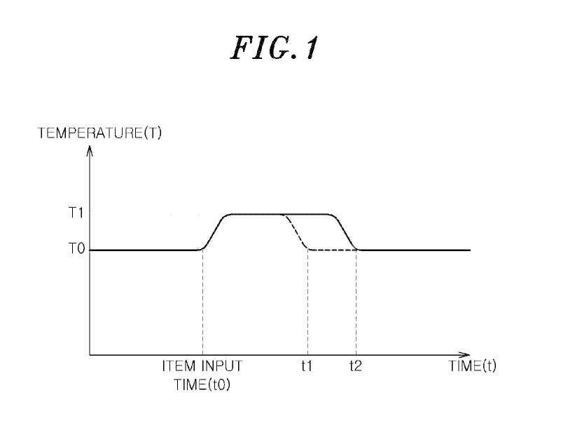

It is appreciated that, if an item in the refrigerator with a higher-than-ambient temperature (e.g., a newly introduced item) can be located, cool airflow can be concentrated on the located item. As a result, the refrigerator temperature can be brought back to the predetermined ambient temperature T₀ from T₁ in a relatively short time (e.g., at t1 rather than t2 as indicated by the dotted line in FIG. 1).

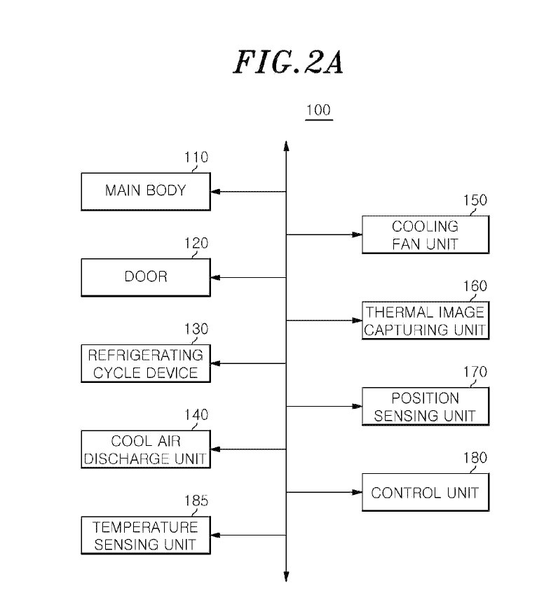

FIGS. 2A and 2B illustrate a configuration of an exemplary refrigerator 100 according to an embodiment of the present disclosure.

Referring to FIG. 2A, refrigerator 100 may include a main body 110 having a storage space maintained at a cool temperature. A door 120 is mounted on the main body. A refrigerating cycle device 130 can generate and supply cool air to the storage space. The cool air discharge unit 140 can discharge cool air into the storage space. A cooling fan unit 150 redirects the discharged cool air and enhances its flow rate.

According to the present disclosure, the refrigerator has a thermal image capturing unit 160 capable of detecting a stored item with a higher-than-ambient temperature. The refrigerator also includes a position sensing unit 170 capable of sensing a position of a particular item in the storage space. A control unit 180 can control a temperature and/or a direction of the cool air discharged from the cool air discharge unit 140 based on the sensed temperature and position of the item. A temperature sensing unit 185 is used to measure a temperature at a particular position in the storage space. However, this is just illustrative and, in various other embodiments, at least one of the above components may be omitted or other components may be added.

FIG. 2B illustrates a refrigerator embodied with the components depicted in FIG. 2A. Referring to FIG. 2B, the interior space defined by the main body 110 is divided into a plurality of segments or chambers by partitions 190. The door 120 is coupled to the main body 110 and isolates the storage space from the outside when closed. The thermal image capturing unit 160 (FIG. 2B) is capable of sensing a temperature distribution of the refrigerator, and the temperature of a small volume therein, e.g., a particular item. At least one position sensing unit 170 is installed and can sense a position of a particular stored item. The cooling fan unit 150 is configured to blow the cool air discharged from the cool air discharge unit 140 into the storage space. The orientation of the fan unit 150 is adjustable and so is the discharge direction of the cool air. However, the configuration depicted in FIG. 2B is merely illustrative. The relative positions and coupling structures and various other aspects of the above components can be implemented in various other manners without departing from the scope of the present disclosure.

Hereinafter, the refrigerator 100 according to an embodiment of the present disclosure will be described with reference to FIGS. 1, 2A and 2B.

The main body 110 refers to a frame of the refrigerator 100, and a storage space is defined by the frame.

The refrigerating cycle device 130 is included in the main body 110, and performs compression, condensation and evaporation processes to generate cool air to be supplied to the storage space. The refrigerating cycle device 130 can be implemented using various techniques well known in the art.

The cool air discharge unit 140 is coupled to the refrigerating cycle device 130 and may be embodied as an opening formed in the main body 110. The discharge unit 140 discharges the cool air from the refrigerating cycle device 130 to the storage space. In the case in which the refrigerator 100 is divided into a plurality of storage chambers, each chamber may have at least one cool air discharge unit.

The thermal image capturing unit 160 is configured to sense a temperature of a particular item, e.g., in a non-contact manner.

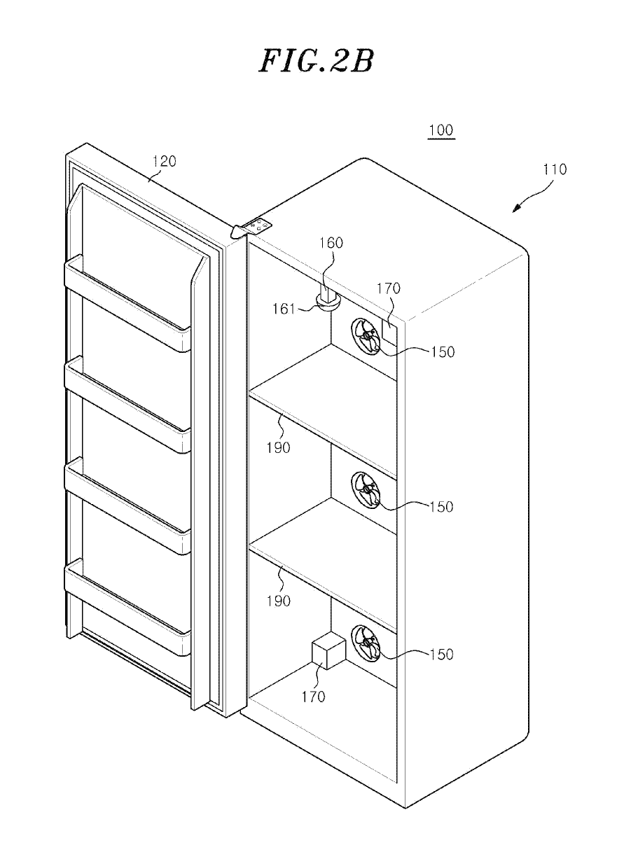

The thermal image capturing unit 160 may be disposed on a ceiling surface inside the storage space of the refrigerator 100. For example it may be disposed at a center region of the ceiling as shown in FIG. 3 (view of the refrigerator observed from the ceiling surface). In this configuration, the thermal image capturing unit 160 can sense a temperature of an item 50 when aiming down from the ceiling surface.

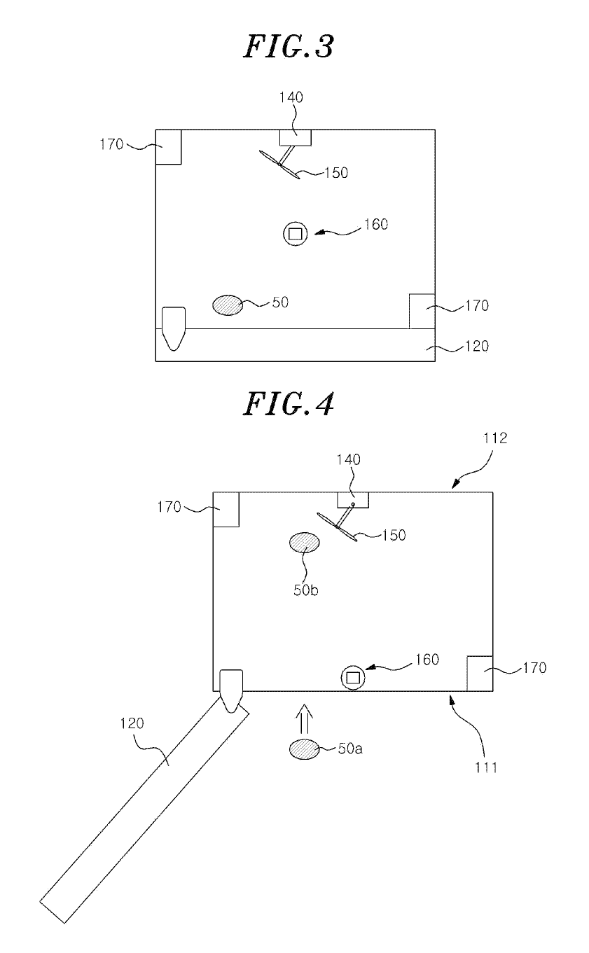

However, the thermal image capturing unit 160 may be disposed in any other suitable location within the refrigerator. For example, the thermal image capturing unit 160 may be disposed on the ceiling and close to the door 120 or the front side 111 of the refrigerator as shown in FIG. 4 (view of the refrigerator observed from the ceiling surface). In this case, the thermal image capturing unit 160 may sense not only a temperature of an existing stored item 50b in the storage space, but also a temperature of an item 50a as soon as it is transferred into the storage space.

As shown in FIG. 2B, the thermal image capturing unit 160 may have a lens 161 with a wide angle of view which enables the unit 160 to sense a temperature distribution of an expanded region or even the entire storage space.

The position sensing unit 170 may be capable of sensing a lateral position and vertical position of an item.

In some embodiments, the refrigerator has multiple segments arranged vertically. The sensing unit can identify a certain segment storing the item.

The vertical position may correspond to a distance from the bottom surface of the refrigerator 100 to the stored item. The combination of the lateral and vertical positions can be used to locate a particular item within the refrigerator.

The position sensing unit 170 may include a sensor for sensing the lateral and vertical positions of an item. One position sensing unit 170, as shown in FIGS. 2B, 3 and 4, may be disposed at each diagonal corner of the refrigerator (one position sensing unit at one corner and another position sensing unit at another corner which is not adjacent to the above corner).

With multiple storage chambers, a position sensing unit may be disposed at each of the chamber. However, this position sensing unit arrangement is merely exemplary, and embodiments of the present disclosure are not limited thereto.

For example, the position sensing unit may include an infrared sensor, as disclosed in Korean Patent Laid-open Publication No. 2011-0057083.

Based on the item temperature sensed by the thermal image capturing unit 160 and the item position sensed by the position sensing unit 170, the control unit 180 automatically controls the cool airflow direction and/or temperature to achieve concentrated cooling on the sensed item.

More specifically, the thermal image capturing unit 160 can sense if a stored item has a higher-than-ambient temperature and transmit the sensed result to the control unit 180. The position sensing unit 170 can sense the lateral and vertical positions of the high-temperature item and transmits the sensed result to the control unit 180.

Based on the sensed results from units 160 and 170, the control unit 180 automatically performs concentrated cooling towards the high-temperature item. For example, in the case in which the storage space is divided into a plurality of chambers by at least one partition 190 and at least one cool air discharge unit 140 is disposed at each of the chamber, the thermal image capturing unit 160 can sense a temperature of an item and transmit the sensed result to the control unit 180. The position sensing unit 170 can locate a region in which the high-than-ambient-temperature item is placed and transmit the sensed result to the control unit 180. Accordingly, the control unit 180 can control the flow rate of the cool air to be increased and/or its temperature decreased. The control unit also controls the cool airflow to be directed to the detected location of the item, thereby achieving concentrated cooling for the particular location.

Concentrated cooling according to the embodiments present disclosure can lower the temperature of a particular item more rapidly than undirected cool air circulation over the entire refrigerator. As a result, the high-than-ambient-temperature item can be cooled off more rapidly. Its impact on elevating the ambient temperature of the refrigerator is advantageously reduced. As a result, power consumption of the refrigerator may be beneficially reduced.

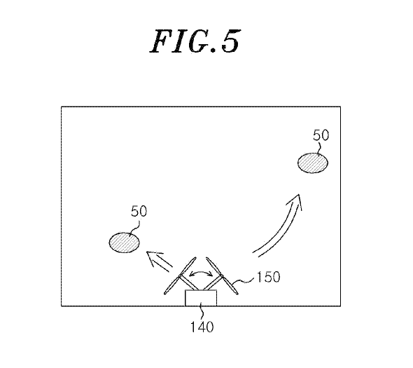

In another example, the control unit 180 may control the cool air discharged from the cool air discharge unit 140 to be directed toward the located high-than-ambient-temperature item, which will be described with reference to FIG. 5 (view of the refrigerator observed from the ceiling surface).

Referring to FIG. 5, the refrigerator 100 according to an embodiment of the present disclosure may further include a cooling fan unit 150. The cooling fan unit 150 may provide the circulation force for the cool air discharged from the cool air discharge unit 140 to circulate in the storage space.

Further, the cooling fan unit 150 may be controlled by the control unit 180 to move (laterally and/or vertically) or rotate so as to allow the strongest portion of the cool airflow to be directed to the detected location, thereby achieving concentrated cooling at the location. FIG. 5 is a view illustrating that the cooling fan unit 150 can swivel by an angle as instructed by the control unit 180 and so blow the cool airflow in the direction.

The cooling fan unit 150 may include fan blades for providing the cool air with circulation force, a motor unit for driving the fan, and a driving unit to swivel the cooling fan unit 150 so that the cooling fan unit 150 faces the direction as instructed by the control unit 180.

Accordingly, such directed cooling can lower the temperature of a high-temperature item more rapidly than cooling through cool air circulation in the entire storage space. Thus, as indicated by the dotted line in FIG. 1, the time for lowering the temperature inside the storage space from T₁ to T₀ can be advantageously shortened.

The refrigerator 100 according to an embodiment of the present disclosure may further include a temperature sensing unit 190. The temperature sensing unit 190 may be a temperature sensor configured to measure a temperature inside the storage space. The temperature sensing unit 190 is used to sense the overall temperature inside the storage space. If it senses that the overall temperature inside the storage space has returned to a predetermined temperature, a signal is transmitted to the control unit 180 to reduce or stop concentrated cooling.

As described above, according to an embodiment of the present disclosure, the temperature and position of an item stored in the storage space of the refrigerator can be sensed. Intensive cool airflow can be directed towards the located item based on the sensed results. In this manner, the temperature of the high-temperature item can be lowered more rapidly than unidirectional cooling. As a result, power consumption of the refrigerator may be advantageously reduced.

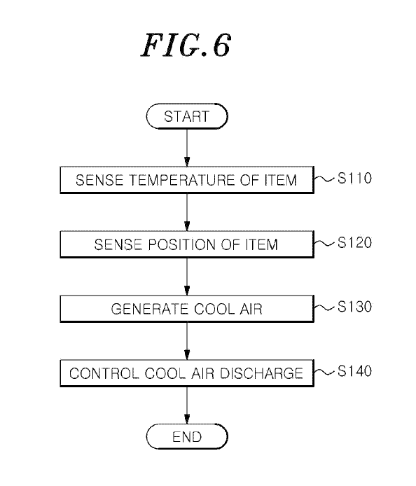

FIG. 6 is a view illustrating a method for controlling a refrigerator according to an embodiment of the present disclosure. The method can be performed by the above-described refrigerator 100 according to an embodiment of the present disclosure.

Referring to FIG. 6, a method for controlling the refrigerator 100 includes: sensing a temperature of a stored item (S110); sensing a position of the item in the refrigerator 100 (S120); generating cool air to be supplied to the storage space storing the item (S130); and automatically controlling cool air discharge by adjusting a temperature and flow direction of cool air based on the sensed temperature and position of the item (S140).

Hereinafter, the method for controlling a refrigerator according to an embodiment of the present disclosure and the accompanying effect will be described with reference to FIGS. 2A through 6.

First, at S110, temperature of an item (S110) is sensed by the thermal image capturing unit 160.

Here, the thermal image capturing unit 160 may be disposed on a ceiling surface inside the refrigerator 100, e.g., in a center region of the ceiling surface as shown in FIG. 3. The thermal image capturing unit 160 can sense the temperatures of the items stored in the refrigerator.

In another example, the thermal image capturing unit 160 may be mounted on the ceiling surface and close to the front door side. In this case, a temperature of an item 50b stored in the storage space can be sensed, and a temperature of an item 50a can be sensed as soon as it is introduced into the storage space.

In S110, the temperature of an item (S110) may be sensed by the thermal image capturing unit 160 through the lens 161 having a wide angle of view.

Next, in S120, the position of the item is detected by the position sensing unit 170.

Here, the position sensing unit 170 may include a sensor for sensing the lateral and vertical positions of an item. The lateral position of an item may indicate a position on a horizontal plane. If the storage space is divided into a plurality of chambers arranged vertically, the lateral position of an item may include information about one of the plurality of chamber, in which the item is stored or into which the item is put.

The vertical position of an item may correspond to a vertical distance from the bottom surface of the refrigerator 100 to the item. In some embodiments, the refrigerator 100 includes a plurality of chambers arranged vertically, the vertical position of an item may include information about one of the plurality of spaces, in which the item is stored or into which the item is put.

Therefore, the position sensing unit 170 may include a sensor for sensing both lateral and vertical positions of an item. Two position sensing units 170, as shown in FIGS. 2B, 3 and 4, may be disposed at two diagonal corners of the refrigerator. The sensing unit may be, for example, embodied as an infrared sensor.

In S130, cool air may be generated by the refrigerating cycle device 130 through compression, condensation and evaporation. Cool air is then supplied to the storage space. Since the process of generating cool air by the refrigerating cycle device 130 is a well-known technology, a detailed explanation thereof will be omitted.

Controlling cool air discharge (S140) may be performed by the control unit 180. The cool air discharged from the cool air discharge unit 140 may be controlled based on the temperature sensed in the temperature sensing process (S110) and based on the position sensed in the position sensing process (S120), thereby achieving concentrated cooling.

More specifically, the cool air discharge controlling process (S140) may be performed such that the cool air discharged from the cool air discharge unit 140 is directed to the high-than-ambient-temperature item based on a sensed location thereof. For example, in the case in which the storage space is divided into a plurality of spaces by at least one partition 190 and at least one cool air discharge unit 140 is disposed in each of the spaces, the thermal image capturing unit 160 senses a temperature of an item and transmits the sensed result to the control unit 180. The position sensing unit 170 senses a location in which the high-than-ambient-temperature item is stored or into which the item is put and transmits the sensed result to the control unit 180. In this case, the cool air discharge is controlled (S140) such that an increased cool airflow is discharged from the cool air discharge unit 140 and provided to the region in which the item is stored, thereby achieving concentrated cooling.

In another example, in S140, the cool air discharged from the cool air discharge unit 140 is controlled and directed toward the high-than-ambient-temperature item by using the cooling fan unit 150. The cooling fan unit 150 may swivel or move laterally or vertically so that the cool air from the cool air discharge unit 140 is directed toward the item, achieving concentrated cooling.

Concentrated cooling can advantageously lower the temperature of a high-temperature item and consequently the ambient temperature (as sensed by the temperature sensing unit 185) in the refrigerator efficiently.

Although not shown in the drawings, the temperature inside the storage space may be sensed by the temperature sensing unit 185. The overall temperature inside the storage space is sensed. When the overall temperature inside the storage space has returned to a predetermined temperature, the control unit 180 sends instructions to stop concentrated cooling.

As described above, according to an embodiment of the present disclosure, a temperature and position of a particular item stored in the storage space of the refrigerator can be sensed. Accordingly, cool airflow can be intensively supplied and directed toward a detected high-than-ambient-temperature item based on the sensed results. Since such concentrated cooling may lower the temperature of a particular item more rapidly than undirected cooling, power consumption of the refrigerator may be advantageously reduced.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A refrigerator comprising:
a thermal image capturing unit configured to sense a temperature of an item placed in a storage space of the refrigerator;
a position sensing unit configured to sense a position of the item in the refrigerator;
a cool air discharge unit for discharging cool air; and
a control unit configured to control a direction of discharged cool air based on the sensed temperature and the sensed position of the item.

2. The refrigerator according to claim 1 further comprising:
a door coupled to a main frame of the refrigerator; and
a refrigerating cycle device for supplying cool air to the storage space.

3. The refrigerator according to claim 1, wherein the thermal image capturing unit is disposed on a top surface defining the storage space.

4. The refrigerator according to claim 2, wherein the thermal image capturing unit is disposed proximate to the door.

5. The refrigerator according to claim 1, wherein the thermal image capturing unit comprises a lens assembly with a wide angle of view.

6. The refrigerator according to claim 1 further comprising:
at least one partition for dividing the storage space into a plurality of chambers,
wherein the position sensing unit is configured to: identify a chamber containing the item; and send identification of the chamber to the control unit.

7. The refrigerator according to claim 1, wherein the position sensing unit is configured to sense a lateral position and a vertical position of the item.

8. The refrigerator according to claim 1 further comprising:
a cooling fan unit coupled to the control unit and configured to: provide a circulation force for the discharged cool air; and adjust a direction of the circulation force in response to a control signal from the control unit,
wherein the control unit is configured to control a temperature or a direction of the cool airflow based on the sensed temperature and the sensed position of the item.

9. A method for controlling a refrigerator, the method comprising:
sensing a temperature of an item stored in a storage chamber of the refrigerator;
sensing a position of the item with reference to the refrigerator;
generating cool air to be supplied to the storage chamber; and
controlling cool air discharge by adjusting a temperature and/or a discharge direction of the cool air based on the temperature and position of the item.

10. The method according to claim 8, wherein the sensing the temperature of the item comprises sensing the temperature by using a thermal image capturing unit disposed within the refrigerator.

11. The method according to claim 8, wherein the sensing the temperature of the item comprises sensing the temperature of the item using a thermal image capturing unit disposed on a ceiling surface inside the refrigerator and proximate to a door of the refrigerator.

12. The method according to claim 8, wherein the refrigerator comprises a plurality of storage chambers, and wherein the sensing the position of the item comprises identifying the storage chamber containing the item.

13. The method according to claim 8, wherein the sensing the position of the item comprises sensing a lateral position of the item and a vertical distance from a bottom surface of the refrigerator to the item.

14. The method according to claim 8 further comprising:
causing a cooling fan unit to face the item based on the temperature and the position; and
directing cool air towards the item by using the cooling fan unit.
